(19) United States
(12) Patent Application Publication
(10) Pub. No.: US 2001/0039546 A1
(43) Pub. Date: Nov. 8, 2001

(54) System and method for obtaining and storing information for deferred browsing

(76) Inventors: Michael R. Moore, Rancho Cordova, CA (US); Daniel A. Kaye, Folsom, CA (US); Peter A. Tjeerdsma, Fair Oaks, CA (US); Aaron J. Welton, Fair Oaks, CA (US)

Correspondence Address: Audrey A. Millemann, Weintraub Genshlea Chediak Sproul Law Corporation, 11th Floor, 400 Capitol Mall, Sacramento, CA, 95814, US

(21) Appl. No.: 09/849,376

(22) Filed: May 4, 2001

Related U.S. Application Data
(60) Provisional application No. 60/201,964, filed on May 5, 2000.

(51) Int. Cl. G06F 7/00; G06F 17/30

(52) U.S. Cl. 707/10; 345/700

(57) ABSTRACT

A system and method are disclosed which allow a user to capture and manage information for later review without interrupting the user's current activity, such as browsing the web, viewing streaming media, or operating a mobile computing device while traveling. The system includes a user interface, a local database application, and: a web browser and web browser plug-in, a streaming media server and streaming media player application, or a GPS unit. The method for capturing information while using a web browser or a streaming media player application includes the steps of selecting an object, obtaining local origination data, and storing the object and local origination data. The method for capturing information while using a mobile computing device having GPS capability includes activating a GPS capture function, obtaining local origination data, storing GPS objects and local origination data, and generating an index to geographically relevant objects.

### CROSS-REFERENCE TO RELATED APPLICATION

The present application claims the benefit of U. S. provisional patent application No. 60/201,964, filed on May 5, 2000 and entitled “Link Search Tablet-Deferred Browsing System,” which is hereby incorporated by reference.

### BACKGROUND OF THE INVENTION

1. Field of the Invention

The present invention relates generally to the convenient capturing and management of information for future reference without interrupting the current activity such as web browsing, watching a streaming media show, or using a mobile computing device with GPS navigation capability.

2. Description of Related Art

Existing web browsers allow the creation of a list of “favorite” web links, but this approach requires a multiple-step manual operation on the part of the user to add a desired link to the list, and provides no simple method for searching, organizing or otherwise maintaining such links.

Some existing streaming media viewing applications transmit data such as web links or other information along with the media stream for display in a window alongside the media viewing window. However, such links are often displayed for only a short time before being replaced with new information, thus requiring prompt and deliberate action on the part of the user in order to explore a given link or to store it for future use.

Existing search engines and web knowledge base systems require one or more multiple-step deliberate actions on the part of the user to search and find relevant links, and they provide no convenient methods to store results from multiple search attempts, nor do they allow the user to easily maintain a history of the success or failure of given search attempts in order to avoid duplication of effort.

Existing database software systems can be used to create and maintain lists of web links, but such systems require expertise on the part of the user in order to create such databases, and also require multiple-step manual operation or extensive custom programming in order to update and maintain the usefulness and relevance of the data.

Some existing GPS navigation tools contain geographical databases which can be used to identify businesses or other points of interest near the user's current location, but they do not allow the user to conveniently capture the current location for later review of such geographically relevant information.

Thus, there is a need for a system and method that allows a user to obtain information for later review without interrupting the current activity.

### SUMMARY OF THE INVENTION

The present invention is a computerized system and method which enables a user to easily capture and manage useful information (such as web links, advertisements, or points of interest while traveling) for later review without interruption of the current activity (such as browsing web pages, using a web search engine, viewing a media stream, or operating a mobile computing device while traveling). This “transparency” of operation is supported through use of a variety of modes for manual or automatic capturing of information optimized for use with these different types of activities.

To facilitate the organization and location of desired items, all captured information is automatically enriched through the addition of metadata which can be used for organizing and navigating the resulting database of information, including filtering, sorting and searching operations.

The system includes a user interface, a local database application, and one of: a web browser and web browser plug-in, a streaming media server and a streaming media player application, or a GPS unit. A central database service may also be included as a part of the system to support a variety of additional features such as web searches for additional information related to a captured item, public commentary on or reviews of specific items, and points of interest near the user's current location.

Through use of industry-standard plug-in protocols and data formats, the system can be compatible with most common web browsers, streaming media players, and GPS navigation systems. The system can also re-present information from the local database or the central database formatted as one or more new web pages, using industry standard web database protocols such as CGI, SQL, or Cold Fusion.

The invention includes a method for capturing information while using a web browser or a streaming media player application, and includes the steps of selecting an object, obtaining local origination data, and storing the object and the local origination data. The invention also includes a method for capturing information while using a mobile computing device having GPS capability, and includes the steps of activating a GPS capture function, obtaining local origination data, storing a GPS object and local origination data, and generating an index to geographically relevant objects.

### BRIEF DESCRIPTION OF THE DRAWINGS

FIG. 1 is a block diagram of the system architecture, indicating user interaction, data storage, and data flow.

FIG. 2 is a flowchart representing user interaction and data flow when capturing information while using a web browser.

FIG. 3 is a flowchart representing user interaction and data flow when capturing information while viewing a streaming media presentation.

FIG. 4 is a flowchart representing user interaction and data flow when capturing information while using a mobile computing device with GPS capability.

### DETAILED DESCRIPTION OF THE PREFERRED EMBODIMENTS

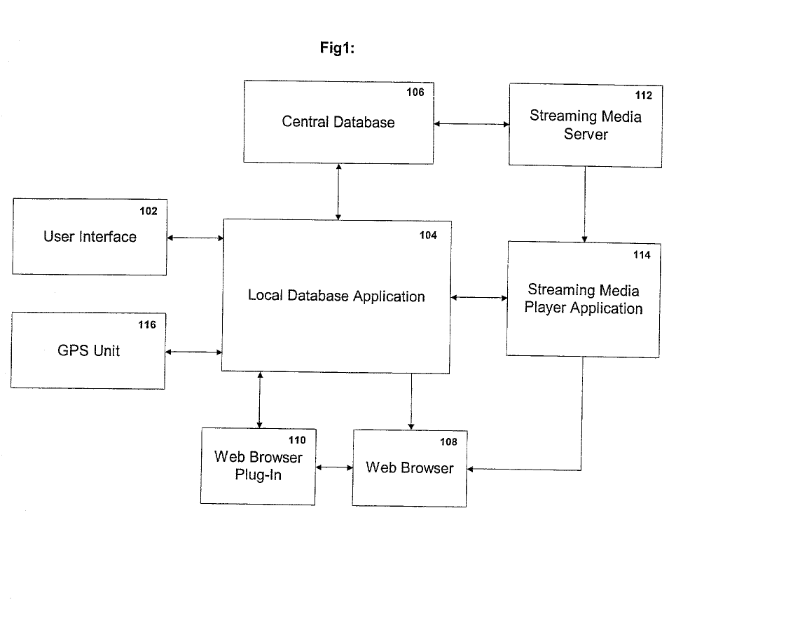

FIG. 1 is a block diagram of the architecture of system 100. System 100 may be implemented in either a desktop personal computer or a mobile computing device, such as a laptop computer or a hand-held Palm OS or Microsoft Pocket PC based organizer, or other mobile device such as a cellular telephone or “wristwatch” computer. When implemented in a desktop personal computer, system 100 includes user interface 102, local database application 104, and at least one of: (1) web browser 108 and web browser plug-in 110; or (2) streaming media server 112 and streaming media player application 114. When implemented in a mobile computing device, system 100 includes user interface 102, local database application 104, and at least one of: (1) web browser 108 and web browser plug-in 110; (2) streaming media server 112 and streaming media player application 114; or (3) GPS unit 116. When implemented in either a desktop personal computer or a mobile computing device, system 100 may also include central database 106.

User interface 102 is the user interface for system 100, where the user would choose the desired method for capturing objects, view captured objects and their relevant data, send commands to activate a chosen object in the web browser, and otherwise interact with system 100. User interface 102 can be implemented as a separate software application; included as functions of local database application 104; implemented as a shared code library that can be accessed by other applications; incorporated into web browser plug-in 110 for display on the user interface of web browser 108; accessed through web browser 108 in the form of menus, pop-ups, or other standard HTML tools on one or more web pages; or any combination of the above. In FIG. 1, user interface 102 is shown as a separate software application.

Local database application 104 is the primary application software for the system, installed on either a desktop personal computer or a mobile computing device. Local database application 104 captures information from web browser 108 (through web browser plug-in 110), streaming media player application 114, or GPS unit 116. This information consists of objects such as web links (URL), images, articles, quotations, advertisements, product reviews, comparisons between prices on different vendors' web catalogs, and businesses, billboards, landmarks, or other points of interest near the user's current physical location while using a mobile computing device. These objects are stored by local database application 104 in one or more database files, along with metadata such as local origination data, object description data, and geographical data, in order to facilitate easy and rapid retrieval of the objects. Local origination data is information related to the capture of the object, such as the identity of the user, the current date and time, and the computer or device being used. For objects captured from web browser 108, local origination data will also include information related to the source of the object on the world wide web, such as the source of the captured data such as a company name, contact information and web site, and/or the chain of events that led to the user's location of that object data such as a search request or history of recent links. For objects captured from streaming media player application 114, local origination data will also include information related to the source of the media stream, including any information relating to the source of the media stream on the world wide web (as described in the previous sentence), and information related to the stream itself, such as the name of the stream and any available stream identification data, along with one or more time-code pointers which indicate the point in time during the media stream at which the object was sent, and, if the user captured the object manually, the time point at which the user selected the object to be captured, which can then be used to derive the event(s) in the media stream that may have inspired the user to respond. For objects captured from GPS unit 116, local origination data will also include geographical information related to the creation of the object, such as the current GPS coordinates and vector (direction and speed of travel) obtained from GPS unit 116. Object description data may include the type of object, a short descriptive title, a longer detailed description, keywords, a custom graphic icon image, and a unique identifier or index code from central database 106. Additional object description data could include e-commerce information such as a product manufacturer's URL, a product ID number, the current price and shipping costs, and information about promotional offers.

Local database application 104 modifies the behavior of web browser 108 and web browser plug-in 110, streaming media player application 114, or GPS unit 116 to facilitate the convenient capture of information such as object data and metadata. This can be implemented by using industry standard programming or operating system interfaces such as ActiveX controls, COM interfaces, and/or the programming interfaces supplied by the manufacturers thereof, in order to intercept data and user interaction with, and/or make changes to the user interface controls for web browser 108, streaming media player application 114, or GPS unit 116. These modifications are implemented in such a way as to allow the user to make use of one or more modes of capture, which the user can choose via user interface 102. These modes of capture include automatic or manual modes that may behave in different fashions depending on which of web browser 108, streaming media player application 114, or GPS unit 116 is being utilized. The manual modes include double-click, single-click, click-and-hold, right click, gestures, and highlighting.

In the automatic mode, information is captured automatically depending on the activity in which the user is engaged. If the user is surfing the web, every link the user accesses in web browser 108 will be automatically captured into local database application 104 without interrupting the browsing session. If the user is watching or listening to streaming media, every object included in the transmission will be captured, along with any associated metadata. If the user is operating a mobile computing device with GPS unit 116 while traveling, all objects in the geographical area near the user's path of travel are captured along with any associated metadata.

In the double-click mode, the user may use normal single-click operation to surf the web without capturing links, but if a desirable link is encountered, the user may double-click on it to capture it without interrupting the browsing session.

In the single-click mode, when the user clicks on a link, it will be captured into local database application 104, but the link will actually not be followed by the browser. This is a useful mode for streaming media player application 114, so that the user may capture desired objects for later perusal without interrupting the media stream.

In the click-and-hold mode, the user would click down the mouse and hold it for a period of time (user-adjustable) to indicate that a link should be captured.

In the right-click mode, a manual-operation menu would appear, allowing the user to specify whether to capture a particular link or perform other operations, such as capturing all the links on a given web page, or possibly even capturing the entire web site.

In the gestures mode, gestural motion of the mouse (or other pointing device such as the stylus or touch screen of a mobile computing device) can be used to indicate the desired action. Some examples of common gestures might be “circling” an object that is desirable, “crossing out” one that is not wanted, or “dragging” a desired object from the web browser window and dropping it on top of user interface 102.

In the highlighting mode, the user could click and drag across a block of text such that any text and images the user highlights in this way are excerpted from a web page and saved in a local file directory on the user's computer. This could be implemented so as to work in the same way as a standard text highlighting tool, a “rubber band” box, or a “freehand” circling tool.

Other commands from user interface 102 can instruct local database application 104 to perform other actions, such as view a listing of the resulting object database(s), view additional details on an object, sort or filter the object list by various criteria, generate one or more new web pages containing a report based on the above operations, activate a particular object for display in web browser 108, or perform basic maintenance operations on the database such as deleting unneeded objects.

Central database 106 is a remote networked storage system for information that might be shared among multiple users, such as objects and metadata, other information or services such as public reviews or user comments. Central database 106 could be implemented using an industry standard database protocol such as SQL on a local area network or internet server. Central database 106 may also offer additional software services to interface with other networked database services such as Internet search engines or knowledge bases, in order to perform additional information gathering operations.

Web browser 108 is a standard web-browser application, such as Microsoft Internet Explorer or Netscape Navigator. Web browser 108 is interfaced with web browser plug-in 110 through industry standard plug-in protocols. Through standard browser and operating system interfaces, web browser 108 can also display web objects that have been selected for activation by the user from local database application 104 or streaming media player application 114.

Web browser plug-in 110 is a plug-in application interfaced with web browser 108 through an industry standard plug-in protocol such as Windows ActiveX or Java, or through application programming interfaces (APIS) provided by the browser manufacturer. Web browser plug-in 110 modifies the behavior of web browser 108 in order to implement the modes of capture.

Web browser plug-in 110 can also include other features to enable additional automatic services while browsing. One example of such services would be an auto-search feature that watches where the user goes on the web after making one or more specific search requests from central database 106. Based on the user's original search request(s), the auto-search feature would “follow along” as the user manually searches the web, doing additional searches and displaying other suggested links that might lead to the desired information. The auto-search feature would also maintain a history of the user's responses to its suggestions in order to eliminate links that have been determined useless and otherwise refine its search criteria.

Streaming media server 112 is a remote, networked software application or a service, making use of a streaming media encoder such as Windows Media Encoder or Real Media Producer. Streaming media server 112 may include a collection of collateral content objects and metadata that can accompany a given piece of streaming media content. As the stream is broadcast, objects from streaming media server 112 can be pushed to streaming media player application 114 at the time assigned for each item and can appear in streaming media player application 114 or in web browser 108. Streaming media server 112 may obtain existing objects from central database 106 or, if new objects have been created, may upload them into central database 106 so that those objects will be accessible to other users without viewing the stream. If a stream is being viewed that does not have collateral content objects associated with it, but does have closed captioning or other form of data being sent along with it, this data can be captured for other uses such as keyword-based searches.

Streaming media player application 114 is software such as Windows Media Player or Real Player which allows the user to view streaming media content. Streaming media player application 114 may have additional features to take advantage of collateral content objects that are transmitted from streaming media server 112 for display at assigned times during the broadcast. When an automatic link capture mode is active, or the user manually selects an object to be captured, the object and any associated metadata are stored in local database application 104 for later perusal. The user may also choose to activate an object while watching or listening to a media stream, in which case the object is sent to web browser 108 for immediate display.

GPS unit 116 is a satellite navigation system that can be accessed by local database application 104. When the user wishes to remember something related to their location or path of travel, the current GPS coordinates and direction of travel can be used to derive geographically relevant information.

### Capturing Information from Web Browser 108

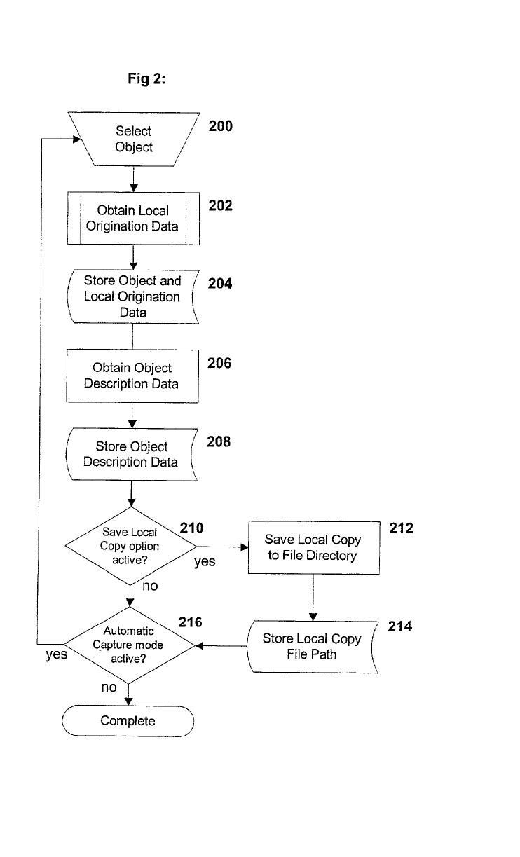

FIG. 2 is a flowchart of the steps of a method for obtaining and storing information from web browser 108 via web browser plug-in 110, such as would be done if the user were surfing the web. In step 200, the user selects an object to be captured, using either the automatic capture mode or one of the manual modes of capture. In step 202, local origination data is obtained by local database application 104 from information available on the user's computer at the time of capture. In step 204, the object and local origination data are stored by local database application 104 into appropriate fields in a new database record for the object, or, if the object has previously been captured, the existing record is updated.

In step 206, any available metadata such as object description data is obtained, either by querying central database 106 with reference to the object's URL, or by receiving data embedded in the object itself, such as in an ActiveX or Java object. In step 208, the metadata is stored by local database application 104.

Steps 202 through 208 can be implemented as one or more separate software tasks and do not have to be implemented in this sequence, but could be executed in parallel or in a different sequence, if necessary, to optimize the execution of the main thread of this process.

If, in step 210, it is detected that the user has activated a function in local database application 104 to save a local copy of the objects being captured, then, in step 212, the web page and other objects located at the selected URL are downloaded and saved to a local file directory on the user's computer. In step 214, the file path location of this local copy is stored into the object's database record by local database application 104. Steps 212 and 214 can be implemented as separate software tasks to optimize the execution of the main thread. If, in step 210, it is detected that the user has not activated a function in local database application 104 to save a local copy, then step 216 is performed, bypassing steps 212 and 214. If, in step 216, it is determined that the user has chosen the automatic capture mode, the process is repeated from step 200 for each object which the user has selected. If, in step 216, it is determined that the user has not chosen the automatic capture mode, then the process is complete.

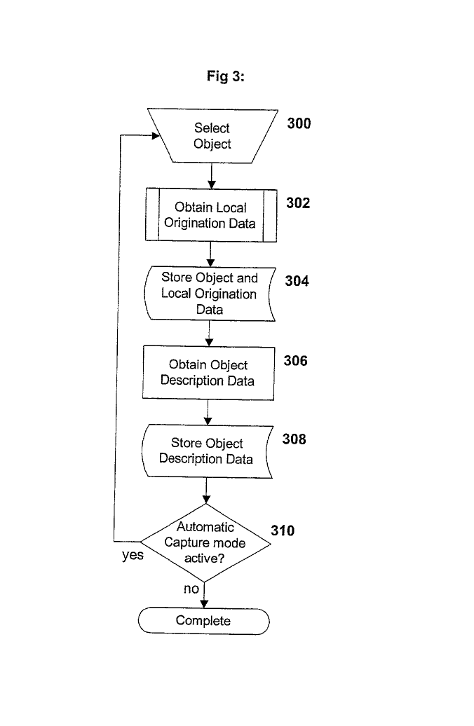

Capturing Information from Streaming Media Player Application 114 FIG. 3 is a flowchart of the steps of a method for obtaining and storing information while using streaming media player application 114 to watch or listen to a media stream.

In step 300, the automatic capture mode is active and an object has been received by streaming media player application 114, or the user has used a manual capture mode to capture an object from streaming media player application 114. In step 302, local origination data is obtained by local database application 104. In step 304, the object and local origination data are stored by local database application 104 into appropriate fields in a new object record, or if the object had previously been captured, the existing object record is updated.

In step 306, any available metadata such as object description data is obtained from streaming media player application 114, central database 106, or by receiving data embedded in the object itself (described in step 206 above). In step 308, the metadata is stored by local database application 104.

Steps 302 through 308 can be implemented as one or more separate software tasks and do not have to be implemented in this sequence, but could be executed in parallel or in a different sequence, if necessary to optimize the performance of the main thread.

If, in step 310, it is determined that the user has activated the automatic capture mode, then the process is repeated from step 300 for each object which is received from streaming media server 112. If, in step 310, it is determined that the user has not chosen the automatic capture mode, then the process is complete.

### Capturing GPS Objects Using GPS Unit 116

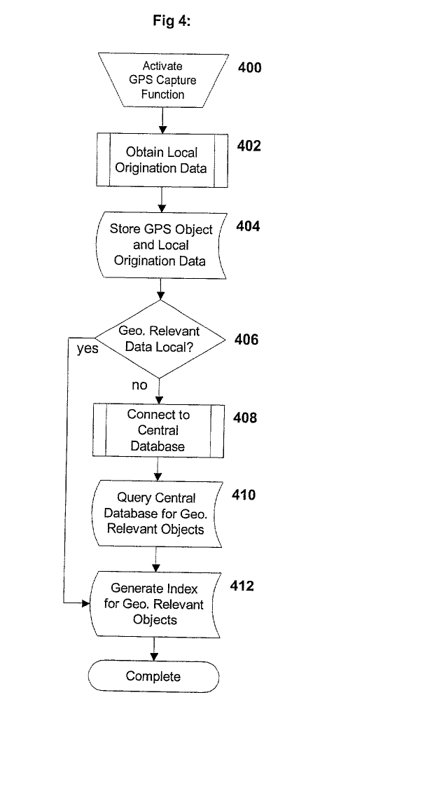

FIG. 4 is a flowchart of the steps of a method for capturing a GPS object while operating a mobile computing device with GPS unit 116. In this scenario, the user has activated a GPS capture function in local database application 104 to generate a GPS object. A GPS object is a collection of information containing the GPS coordinates and vector (or, if the user has activated the automatic capture mode, a path of travel) obtained from GPS unit 116 and any associated metadata obtained at the time the user captured the GPS object. This GPS object can then be used immediately or at a later time to obtain and store geographically relevant objects, which contain data on items of interest located near the GPS coordinates or path of travel. Each geographically relevant object is a collection of data about an actual physical item (such as a billboard advertisement, a place of business, building, landmark, or other point of interest), containing the geographical coordinates of the physical item it refers to, along with any other available physically descriptive information such as its street address or highway location, on which side of the street or highway it is located, its orientation in space, its height, size, and color, and could also include one or more digital photographs of the object itself. Each geographically relevant object may also include metadata such as object description data.

In step 400, the user activates a GPS capture function in local database application 104. This can be implemented to make use of a physical button on the mobile computing device, such as for safe and convenient operation while driving a car. This capture function can also be implemented to make use of a function in GPS unit 116 in which a path of travel is recorded. In step 402, local origination data is obtained by local database application 104. This can be implemented using application programming interface (API) protocols supplied by the GPS manufacturer or by directly accessing the GPS hardware. In step 404, the GPS object and the local origination data are stored by local database application 104 into a new record for a GPS object. Steps 402 and 404 can be implemented as one or more separate software tasks and do not have to be implemented in this sequence, but could be executed in parallel or in a different sequence, if necessary to optimize the performance of the main thread.

If, in step 406, it is determined that local database application 104 already has access to data that is relevant to the GPS object captured on the mobile computing device, (for example, if the user has previously captured a GPS object in the immediate locality, or if such geographically relevant data is otherwise available locally, such as from a geographical database associated with GPS unit 116), then step 412 is performed, bypassing steps 408 and 410. If, in step 406, it is determined that local database application 104 does not have access to geographically relevant data, then, in step 408, a connection is made to central database 106 via wireless connection (such as cellular modem or digital wireless network). In the absence of an available wireless connection, step 408 and the following steps can be deferred until a network connection can be established, either by regaining cellular contact, or by making a physical connection (such as local area network, modem or docking station) in order to allow communication with central database 106.

In step 410, local database application 104 generates a query to central database 106, central database 106 responds by sending any available geographically relevant objects which are identified as being in proximity to the user's location or path of travel when the GPS capture function was activated, and each of these resulting objects are stored by local database application 104 into a new database record.

In step 412, an index to the geographically relevant objects is generated by local database application 104 in order to relate the geographically relevant objects to the GPS object created in step 404. Thus, when the user reviews the GPS object via user interface 102, the indexed geographically relevant objects can be listed in relation to the GPS object and can then be easily sorted or filtered by their proximity to the user's location, their orientation relative to the user's direction of travel, their appearance, and any other descriptive information that may assist the user in identifying the physical item they wished to recall when they activated the GPS capture function, and any metadata associated with the geographically relevant objects may also be reviewed.

### Viewing. Organizing and Maintaining the Object Database

Local database 104 uses the information and metadata captured, along with the objects, to optimize and improve the functionality of industry standard database functions, such that the user may rapidly and conveniently view, organize, maintain, and otherwise interact with the object database. These functions include viewing a list of objects, expanding and contracting the view of an object to display some or all of the metadata associated with that object, and sorting, filtering and otherwise reorganizing a list of objects. User-defined fields or metadata may also be added to facilitate custom categories or search criteria.

In the case of a GPS object that was captured from GPS unit 116, a list of the geographically relevant objects (related by the index created in step 412 above) can be displayed, and can be sorted or filtered based on their geographical proximity or other criteria (as described in step 410 above).

Through common web database protocols such as CGI, SQL, or Cold Fusion, all the functions described in the previous two paragraphs can also be accessed through web browser 108 in the form of menus, pop-ups or other standard HTML tools on one or more web pages, and the results can be stored as one or more new web pages for publishing to a standard HTML web server.

Local database application 104 also includes a set of standard database maintenance functions that can be accessed through user interface 102, such as to manually delete or archive selected objects, set expiration dates for certain objects, or set time limits beyond which all objects will automatically be deleted or archived.

### Activating Objects

To enable the user to activate a link to an object such as a web page or media stream that was captured for later perusal, local database application 104 can transmit the URL from the appropriate data field in the object's database record to web browser 108 or streaming media player application 114, via standard browser operating system protocols. If a local copy of the contents of that URL was stored (as described in steps 212 and 214 above), then the user will have the option of viewing that local copy instead of activating the URL.

The invention has been described above with reference to the preferred embodiments. Those skilled in the art may envision other embodiments and variations of the invention that fall within the scope of the claims.

What is claimed is:

1. A system for capturing information while using a web browser, comprising:
a user interface;
a web browser plug-in;
a web browser; and
a local database application, wherein the local database application uses the web browser plug-in to modify the behavior of the web browser to obtain and store information without interrupting a user's web browsing activity.

2. The system of claim 1, wherein said local database application provides a mode of capture.

3. The system of claim 2, wherein the user is provided with the opportunity to choose said mode of capture.

4. The system of claim 2, wherein said mode of capture comprises automatically capturing every URL link the user accesses in said web browser.

5. The system of claim 2, wherein said mode of capture permits the user to manually select the information to be captured.

6. The system of claim 1, further comprising a central database for storing metadata and other information shared between multiple users.

7. The system of claim 1, wherein said obtained and stored information includes objects and metadata, and further, wherein said metadata is used to optimize the retrieval of said objects.

8. A system for capturing information while using a streaming media player application, comprising:
a user interface;
a streaming media server;
a streaming media player application; and
a local database application, wherein the local database application modifies the behavior of the streaming media player application to obtain and store information without interrupting a user's viewing of a media stream.

9. The system of claim 8, wherein said local database application provides a mode of capture.

10. The system of claim 9, wherein the user is provided with the opportunity to choose said mode of capture.

11. The system of claim 9, wherein said mode of capture comprises automatically capturing all information received by said streaming media player application.

12. The system of claim 9, wherein said mode of capture permits the user to manually select the information to be captured.

13. The system of claim 8, further comprising a central database for storing metadata and other information shared between multiple users.

14. The system of claim 8, wherein said obtained and stored information includes objects and metadata, and further, wherein said metadata is used to optimize the retrieval of said objects.

15. A system for capturing information while using a mobile computing device having GPS capability, comprising:
a user interface;
a GPS unit; and
a local database application, wherein the local database application modifies the behavior of the GPS unit to capture a GPS object without interrupting a user's current activity.

16. The system of claim 15, wherein said GPS object is used to obtain and store geographically relevant objects.

17. The system of claim 16, wherein said GPS object includes GPS coordinates and vector.

18. The system of claim 16, wherein said GPS object includes a path of travel.

19. The system of claim 15, further comprising a central database for storing metadata and other information shared between multiple users.

20. A computerized method for capturing information while using a web browser, comprising:
selecting an object;
obtaining local origination data; and
storing said object and said local origination data.

21. The method of claim 20, wherein said selecting an object comprises utilizing a mode of capture.

22. The method of claim 21, further comprising:
providing a user the opportunity to choose the mode of capture.

23. The method of claim 20, further comprising:
obtaining object description data; and
storing said object description data.

24. The method of claim 23, wherein:
said obtaining object description data comprises querying a central database with reference to the object's URL.

25. The method of claim 23, wherein:
said obtaining object description data comprises receiving data embedded in the selected object.

26. The method of claim 20, further comprising:
saving a local copy of the selected object; and
storing the file path location of said local copy.

27. The system of claim 20, further comprising:
for each additional object selected, repeating said obtaining and storing of objects and local origination data.

28. A computerized method for capturing information while using a streaming media player application, comprising:
selecting an object;
obtaining local origination data; and
storing said object and said local origination data.

29. The method of claim 28, wherein said selecting an object comprises utilizing a mode of capture.

30. The method of claim 29, further comprising:
providing a user the opportunity to choose the mode of capture.

31. The method of claim 28, further comprising:
obtaining object description data; and
storing said object description data.

32. The method of claim 31, wherein:
said obtaining object description data comprises querying a central database.

33. The method of claim 31, wherein:
said obtaining object description data comprises receiving data embedded in the selected object.

34. The method of claim 31, wherein:
said obtaining object description data comprises receiving data from a streaming media player application.

35. The system of claim 28, further comprising:
for each additional object selected, repeating said obtaining and storing of objects and local origination data.

36. A computerized method for capturing information while using a mobile computing device having GPS capability, comprising:
activating a GPS capture function;
obtaining local origination data;
storing a GPS object and local origination data; and
generating an index to geographically relevant objects to relate said geographically relevant objects to said stored GPS object.

37. The method of claim 36, further comprising:
determining that geographically relevant objects are not available locally; and
querying a central database for said geographically relevant objects.

38. A computer-readable medium having computer-executable instructions for performing a method for capturing information while using a web browser, comprising:
selecting an object;
obtaining local origination data; and
storing said object and said local origination data.

39. A computer-readable medium having computer-executable instructions for performing a method for capturing information while using a streaming media player application, comprising:
selecting an object;
obtaining local origination data; and
storing said object and said local origination data.

40. A computer-readable medium having computer-executable instructions for performing a method for capturing information while using a mobile computing device having GPS capability, comprising:
activating a GPS capture function;
obtaining local origination data;
storing a GPS object and local origination data; and
generating an index to geographically relevant objects to relate said geographically relevant objects to said stored GPS object.
